(19) United States
(12) Patent Application Publication
(10) Pub. No.: US 2022/0284245 A1
(43) Pub. Date: Sep. 8, 2022

(54) RANDOMIZED METHOD FOR IMPROVING APPROXIMATIONS FOR NONLINEAR SUPPORT VECTOR MACHINES

(71) Applicant: Oracle International Corporation, Redwood Shores, CA (US)

(72) Inventors: Dmitry V. Golovashkin, Cary, NC (US); Mark F. Hornick, Andover, MA (US); Marcos R Arancibia Coddou, Hallandale Beach, FL (US); Uladzislau Sharanhovich, San Jose, CA (US)

(73) Assignee: Oracle International Corporation, Redwood Shores, CA (US)

(21) Appl. No.: 17/191,379

(22) Filed: Mar. 3, 2021

(51) Int. Cl. G06K 9/62; G06N 20/10

(52) U.S. Cl. CPC G06K 9/6269; G06N 20/10; G06K 9/6265; G06K 9/6257

(57) ABSTRACT

The disclosed embodiments relate to a system that improves operation of a monitored system. During a training mode, the system uses a training data set comprising labeled data points received from the monitored system to train the SVM to detect one or more conditions-of-interest. While training the SVM model, the system makes approximations to reduce computing costs, wherein the approximations involve stochastically discarding points from the training data set based on an inverse distance to a separating hyperplane for the SVM model. Next, during a surveillance mode, the system uses the trained SVM model to detect the one or more conditions-of-interest based on monitored data points received from the monitored system. When one or more conditions-of-interest are detected, the system performs an action to improve operation of the monitored system.

### BACKGROUND

### Field

The disclosed embodiments generally relate to techniques for improving the performance of supervised-learning models, such as support vector machines (SVMs). More specifically, the disclosed embodiments provide a randomized technique that iteratively improves approximations for nonlinear SVM models.

### Related Art

Support vector machines (SVMs) comprise a popular class of supervised machine-learning techniques, which can be used for both classification and regression purposes. For large scale data sets, the task of allocating and computing the associated large kernels (e.g., Gaussian), which are used to solve the SVM model, becomes prohibitively expensive. More specifically, for such nonlinear kernels, the complexity of an SVM solution technique grows quadratically in memory space and cubically in running time as a function of the number of observations in the data set. This means it is impractical to use SVMs for larger data sets with more than hundreds of thousands of observations, which are becoming increasingly common in many application domains.

To remedy this computing-cost problem, people perform various types of approximations, such as: sampling data points; computing block-diagonal approximations for nonlinear kernels; and performing incomplete Cholesky factorizations. These approximations can significantly reduce computation costs, which makes it practical to analyze large data sets. Unfortunately, the use of such approximations generally produces suboptimal results during classification and regression operations. Moreover, there presently do not exist any techniques for effectively improving these suboptimal results.

Hence, what is needed is a technique for improving approximations for nonlinear SVMs.

### SUMMARY

The disclosed embodiments relate to a system that improves operation of a monitored system. During a training mode, the system uses a training data set comprising labeled data points received from the monitored system to train the SVM to detect one or more conditions-of-interest. While training the SVM model, the system makes approximations to reduce computing costs, wherein the approximations involve stochastically discarding points from the training data set based on an inverse distance to a separating hyperplane for the SVM model. Next, during a surveillance mode, the system uses the trained SVM model to detect the one or more conditions-of-interest based on monitored data points received from the monitored system. When one or more conditions-of-interest are detected, the system performs an action to improve operation of the monitored system.

In some embodiments, while training the SVM model, the system uses a block-diagonal approximation to initialize an active set of support vectors for the SVM model. Next, the system iteratively performs the following operations to improve the SVM model while SVM misclassifications continue to decrease by more than a minimum amount. First, the system randomly selects additional points from the training data set based on an inverse distance to the separating hyperplane for the SVM model. The system then solves a nonlinear kernel for the SVM model based on the active set of support vectors and the additional data points to compute a new active set of support vectors. Then, if the new active set of support vectors produces fewer misclassifications than the active set of support vectors, the system updates the active support vectors with the new active set of support vectors.

In some embodiments, while randomly selecting the additional points, the system selects an additional point x from the training data set with a probability P(x)=(μ+v d(x))^{-β}, wherein d(x) represents a distance from x to the separating hyperplane, and β, v and β represent associated parameters.

In some embodiments, the SVM model is formulated based on one of the following types of kernels: a linear kernel; a polynomial kernel; a hyperbolic tangent kernel; and a radial basis function kernel.

In some embodiments, the monitored system comprises one of the following: a computer system; a database system; a website; an online customer-support system; a vehicle; an aircraft; a utility system asset; and a piece of machinery.

In some embodiments, the data points received from the monitored system include one or more of the following: time-series sensor signals; computer parameters; textual data; numerical data; and image data. In some embodiments, detecting the one or more conditions-of-interest involves detecting one or more of the following: an impending failure of the monitored system; a malicious-intrusion event in the monitored system; a preventive-maintenance condition for the monitored system; a fraud condition for the monitored system; a product-purchasing condition for the monitored system; and a consumer-attrition condition for the monitored system.

In some embodiments, performing the action to improve operation of the monitored system involves one or more of the following: sending a notification to an administrator of the monitored system; performing an action to stop a malicious-intrusion event in the monitored system; scheduling a maintenance operation for the monitored system; performing an action to stop an instance of fraud associated with the monitored system; performing an action to make relevant offers to customers associated with the monitored system; and performing an action to improve satisfaction of a customer associated with the monitored system.

### BRIEF DESCRIPTION OF THE FIGURES

FIG. 1 illustrates an exemplary computing environment including an application and associated customer-support system in accordance with the disclosed embodiments.

FIG. 2 illustrates an exemplary prognostic-surveillance system, which operates on time-series signals obtained from sensors in a monitored system, in accordance with the disclosed embodiments.

FIG. 3A illustrates a maximum margin separating hyperplane for a linear kernel SVM in accordance with the disclosed embodiments.

FIG. 3B illustrates exemplary classes that are not linearly separable in accordance with the disclosed embodiments.

FIG. 4 illustrates an exemplary block-diagonal matrix in accordance with the disclosed embodiments.

FIG. 5 presents pseudocode for a nonlinear kernel SVM in accordance with the disclosed embodiments.

FIG. 6 presents a flowchart illustrating operations the system performs to improve operation of the monitored system in accordance with the disclosed embodiments.

FIG. 7 presents a flowchart illustrating the process of training the SVM model in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Exemplary Computing System Implementation

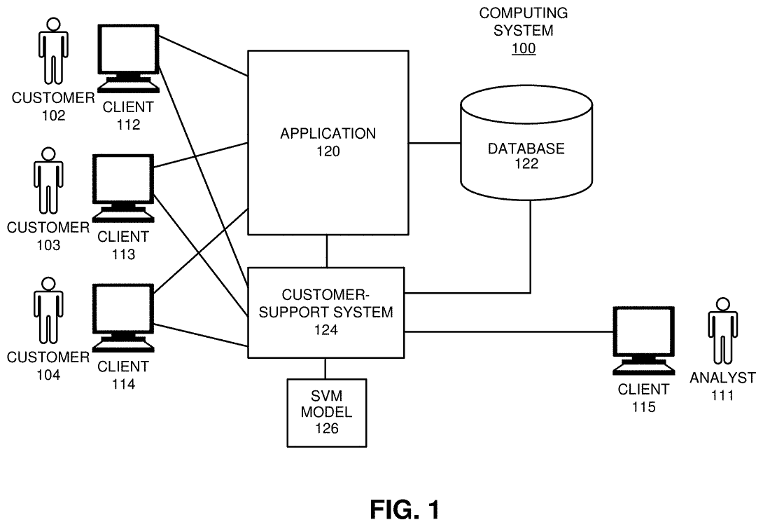

FIG. 1 illustrates an exemplary computing system 100, which includes an application 120 and a customer-support system 124 in accordance with the disclosed embodiments. Within computing system 100, a number of customers 102-104 interact with application 120 through client systems 112-114, respectively. Application 120 is provided by an organization, such as a commercial enterprise, to enable customers 102-104 to perform various operations associated with the organization, or to access one or more services provided by the organization. For example, application 120 can include online accounting software that customers 102-104 can access to prepare and file tax returns online. In another example, application 120 provides a commercial website for selling merchandise. Note that application 120 can be hosted on a local or remote server.

During operation, customer-support system 124 receives various signals from application 120 and associated database system 122. Next, customer-support system 124 analyzes these signals using an associated SVM model 126 to produce information, which is presented to an analyst 111 through client system 115 to facilitate interactions with customers 102-104. For example, SVM model 126 can perform a classification operation based on the signals received from application 120 and database 122 to detect: a possible malicious-intrusion event; a possible fraudulent transaction; or a set of customer interactions that indicate possible dissatisfaction of a customer. Finally, a notification about a detected problem can be presented to analyst 111, which enables analyst 111 to take action to remedy the problem.

### Exemplary Prognostic-Surveillance System Implementation

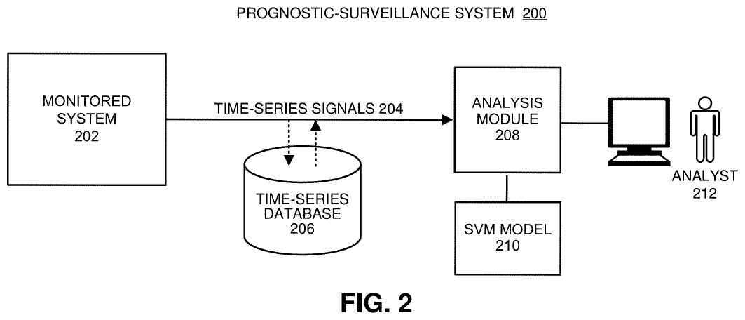

An SVM model can also be used to facilitate the operation of a prognostic-surveillance system. As illustrated in FIG. 2, prognostic-surveillance system 200 operates on a set of time-series sensor signals 204 obtained from sensors in monitored system 202. Note that monitored system 202 can generally include any type of machinery or facility, which includes sensors and generates time-series signals. Moreover, time-series signals 204 can originate from any type of sensor, which can be located in a component in monitored system 202, including: a voltage sensor; a current sensor; a pressure sensor; a rotational speed sensor; and a vibration sensor.

During operation of prognostic-surveillance system 200, time-series signals 204 feed into a time-series database 206, which stores the time-series signals 204 for subsequent analysis. Next, the time-series signals 204 either feed directly from monitored system 202 or from time-series database 206 into analysis module 208. Analysis module 208 uses an associated SVM model 210 to analyze time-series signals 204 to detect various problematic conditions for monitored system 200. For example, analysis module 208 can be used to detect: an impending failure of the monitored system 202; a malicious-intrusion event in monitored system 202; or a condition indicating that preventive maintenance is required for the monitored system 202. A notification about a detected problem can then be sent to analyst 212, which enables analyst 212 to take action to remedy the problem.

### Improving Approximations For Support Vector Machine

We now present details of our new randomized technique that iteratively improves approximations to support nonlinear SVMs. As mentioned above, for large scale data sets, allocating and computing a nonlinear (e.g., Gaussian) kernel for an SVM is often prohibitively expensive. To address the problem, we propose a novel technique. In the first step, it constructs a block-diagonal approximation of the kernel to find an initial set of support vectors S. It then generates new random samples of observations based on their proximity to the separating hyperplane, which improves S after each iteration.

Let X be the input data set. Any point, which is not a support vector X∈X\S, can be safely dropped from the SVM model, because an inactive constraint can be dropped from an optimization problem without changing the optimal solution. Once an initial set of support vectors S has been found, we first drop all X\S points from the data set. It is intuitively clear that any point that is too far from the separating hyperplane (in the transformed feature space) has little chance of ever entering the set of optimal support vectors. Therefore, at the next iteration of our technique, we add points with probability

P(x)=(μ+vd(x))^{-β} (1)

where d(x) is the distance from x to the hyperplane, and μ, v, β>0 are associated parameters. In other words, the closer the point is to the current separating hyperplane, the greater the chance it will be added back to the model. Then we solve the new model, and repeat.

Let us illustrate our approach on the airline on-time data set. Because it has approximately 123 million observations, solving a nonlinear SVM is out of the question (because it is impractical with existing technology to allocate a 123 million-by-123 million square matrix). So we first construct a block-diagonal approximation to find an initial set of support vectors S₀. Say, for example, S₀ has 300 support vectors, which approximate the optimal solution (the optimal set of support vectors). We, of course, cannot allocate a nonlinear kernel for the original data set, but for, say, a 10,300-observation data set, we surely can. So at the next step, we randomly choose 10,000 observations X₀, such that the probability of an observation to be added to the new model is given by formula (1), and solve the SVM model on S₀∪X₀ observations, which gives us S₁. The process is then repeated until some stopping criteria are met.

### Short Description of the Support Vector Machine

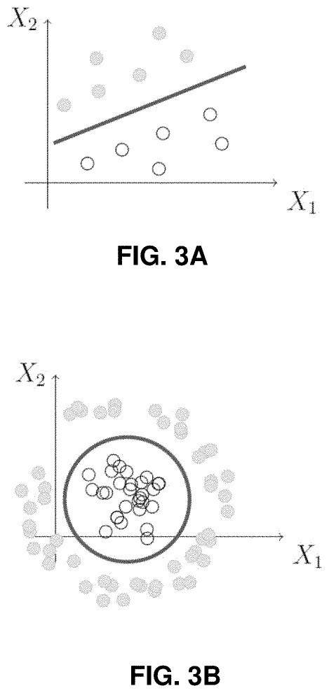

Imagine we have two sets of points and wish to construct a maximum margin separating hyperplane (see FIG. 3A). This model is known as linear SVM. Linear SVM models can be solved very effectively by modern predictor-corrector Interior-Point Methods (IPMs). A parallel distributed IPM implementation can handle billions of observations, a relatively large number of features, including high cardinality factors. Generally speaking, predictor-corrector interior-point techniques exhibit fast and robust convergence and are among the most accurate techniques. In addition to that, IPMs have just a few user-controlled parameters (e.g., primal and dual infeasibility measures, maximum number of iterations); their default values are usually good in practice, and do not require tweaking. A careful IPM implementation is a powerful and reliable optimization engine.

Whenever the classes are not linearly separable (see FIG. 3B), a nonlinear kernel SVM can be an effective solution. However, in stark contrast to the linear SVM, a nonlinear kernel SVM is often a remarkably more challenging problem. A nonlinear SVM (in its dual form) can be formulated as follows

$${minimize}_{α} \frac{1}{2} {\sum }_{ij} {α}_{i} {α}_{j} {y}_{i} {y}_{j} k ( {x}_{i} , {x}_{j} ) - {\sum }_{i} {α}_{i} \\ subject to : \\ \sum {y}_{i} {α}_{i} = 0 \\ 0 \leq {α}_{i} \leq C ∀ i ∈ 1 … M \qquad ( 2 )$$

where xᵢ are data samples (observations), M is the number of observations, yᵢ are class labels, C is the misclassification penalty, and k(·, ·) is the nonlinear kernel function.

Commonly, the following kernels are used in practice:
linear kernel k(xᵢ, xⱼ)=xᵢ^{T}xⱼ
polynomial kernel k(xᵢ, xⱼ)=(1+xᵢ^{T}xⱼ)^{d} for some d>0
radial basis function k(xᵢ, xⱼ)=exp(−γ∥xⁱ−xⱼ∥²) for some γ>0

The biggest challenge in the (2) formulation lies in constructing the quadratic matrix Q: qᵢⱼ≡k(xᵢ, xⱼ). Q can become prohibitively large even for medium data set sizes. To illustrate this, let us consider a one million observation data set, which nowadays would be viewed as rather small. It will require 3.7 terabytes to store the lower (or upper) triangular part of Q. Note, this number (3.7 terabytes) does not depend upon the number of columns in the data set, because Q∈ [symbol] ^{M×M}, and it grows quadratically with the number of observations M.

### Predictor-Corrector Interior-Point Method For SVM

In this section we give a brief overview of the predictor-corrector interior-point method for SVM. As stated earlier, a nonlinear SVM formulation is a classical quadratic programming (QP) model. Let us consider the following standard QP formulation, which is identical to (2), except we no longer use SVM specific notation, but switch to the standard QP nomenclature:

$${minimize}_{x} \frac{1}{2} {x}^{T} Qx + {c}^{T} x \\ subject to : \\ Ax = b \\ l \leq x \leq u \qquad ( 3 )$$

here x is the vector of search variables, Q is a symmetric positive-semidefinite matrix, c represents the linear part of the objective function, l is the vector of lower bounds, u is the vector of upper bounds, and A is a matrix of linear equality constraints.

The dual program to (3) can be stated as follows:

$${maximize}_{x , y , {d}_{1} , {d}_{2}} - \frac{1}{2} {x}^{T} Qx + {b}^{T} y + {l}^{T} {d}_{1} - {u}^{T} {d}_{2} \\ subject to : \\ Qx - {A}^{T} y - {d}_{1} + {d}_{2} = - c \\ {d}_{1} , {d}_{2} \geq 0 \qquad ( 4 )$$

where d₁, and d₂ are dual variables associated with the lower and upper bounds correspondingly, and y is the vector of dual variables associated with the linear equality constraints.

The predictor-corrector interior-point algorithm will solve (twice at each step) the following system of equations, known as the reduced Karush-Kuhn-Tucker (KKT) system:

$$[ \begin{matrix}Q + \frac{{d}_{1}}{{t}_{1}} + \frac{{d}_{2}}{{t}_{2}} & - {A}^{T} \\ - A & 0\end{matrix} ] [ \begin{matrix}Δ x \\ Δ y\end{matrix} ] = [ \begin{matrix}{ρ}_{1} \\ {ρ}_{2}\end{matrix} ] \qquad ( 5 )$$

where the right-hand sides ρ₁ and ρ₂ are defined as follows:

$${ρ}_{1} = {A}^{T} y - c - Qx + {d}_{1} + ( μ - {d}_{1} ( x - l ) - Δ {d}_{1} Δ {t}_{1} ) / {t}_{1} - {d}_{2} - ( μ - {d}_{2} ( u - x ) - Δ {d}_{2} Δ {t}_{2} ) / {t}_{2}$$

$${ρ}_{2} = Ax - b$$

During the predictor step, u and the delta terms are dropped, and the resultant system is solved for the initial estimate of the delta terms. During the corrector step, an estimate of the μ is reinstated to the system, along with nonlinear delta terms and the system is solved again.

To solve KKT, one has to compute the Cholesky factorization

$$Q + \frac{{d}_{1}}{{t}_{1}} + \frac{{d}_{2}}{{t}_{2}} = {LL}^{T} \qquad ( 6 )$$

and then proceed to solve for Δy

AL^{-T}L⁻¹A^{T}Δy=−ρ₂−AL^{-T}L⁻¹ρ₁ (7)

and, finally, restore Δx

Δx=L^{-T}L⁻¹(ρ₁A^{T}Δy) (8)

Of course, no explicit inverses of the lower L, and upper L^{T} triangular matrices are computed; instead, one carries out forward and backward substitutions.

Now we must recall that Q (the SVM kernel matrix) can be prohibitively large; and for most medium to large scale data inputs, it simply cannot be allocated. We next provide an approximation to the nonlinear SVM model, and then show how to improve it.

### Block-Diagonal Kernel Approximation

We consider the most typical case: “tall and skinny” matrices, where M»N. When storing such matrices on a cluster of compute nodes, X is usually partitioned into a collection of row blocks

$$X = [ \begin{matrix}{X}_{1} \\ {X}_{2} \\ … \\ {X}_{P}\end{matrix} ] \qquad ( 9 )$$

where Xₚ∈ [symbol] ^{M}^{ₚ}^{×N}. Granularity of each partition and their number can be arbitrary. By reducing the number of rows in each partition (we can always increase the number of partitions P), we can assume that for each row block Xₚ, its corresponding part of the nonlinear kernel Qₚ=k(xᵢ,xⱼ), ∀xᵢ,xⱼ∈Xₚ can also be stored in memory. In other words, instead of the full matrix Q (which we cannot allocate for all except for the smallest of input data sets), we store only its block-diagonal part

$$\tilde{Q} = [ \begin{matrix}{Q}_{1} & 0 & … & 0 \\ 0 & {Q}_{2} & … & 0 \\ ⋮ & ⋮ & ⋱ & 0 \\ 0 & 0 & … & {Q}_{P}\end{matrix} ] \qquad ( 10 )$$

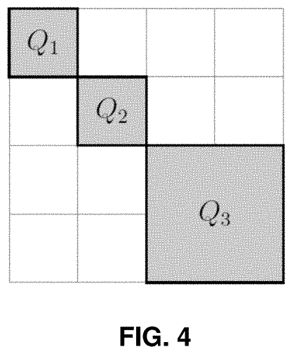

Note that because each partition Xₚ does not necessarily have the same number of rows, correspondingly Qₚ can be of different sizes. See FIG. 4, which presents an example of a block-diagonal matrix, wherein Q₁, Q2 and Q₃ are square matrices of any size, which capture all nonzero elements.

Some of the obvious properties of the \tilde{Q} matrix:
it is also positive-semidefinite
its inverse is also a block-diagonal matrix, of the same shape
a Cholesky factorization, see (6)

$$\tilde{Q} + \frac{{d}_{1}}{{t}_{1}} + \frac{{d}_{2}}{{t}_{2}} = \tilde{L} {\tilde{L}}^{T} \qquad ( 11 )$$

is carried out by each worker independently (“embarrassingly parallel method”).

Introducing Q into the reduced KKT system (5) makes it tractable to store and solve. Understandably, we would not be solving the original nonlinear SVM model, but its block-diagonal approximation, which we will denote dSVM, where ‘d’ stands for “diagonal”.

Having solved dSVM, we found a set of support vectors, which to some extent approximate the optimal solution. Let us consider a hyperplane w^{T}x+b=0 and an arbitrary observation g. The distance from g to the hyperplane is given by

$$d = \frac{\vert {w}^{T} g + b \vert}{\sqrt{{w}^{T} w}} .$$

It is intuitively clear, if the distance d is large, the chance of g being a support vector is small; therefore, we do not need to keep the observation in the optimization model. In the transformed feature space, the core expression |w^{T}y+b| translates to

$$\vert b + {\sum }_{i} {α}_{i} {y}_{i} k ( {x}_{i} , g ) \vert \qquad ( 12 )$$

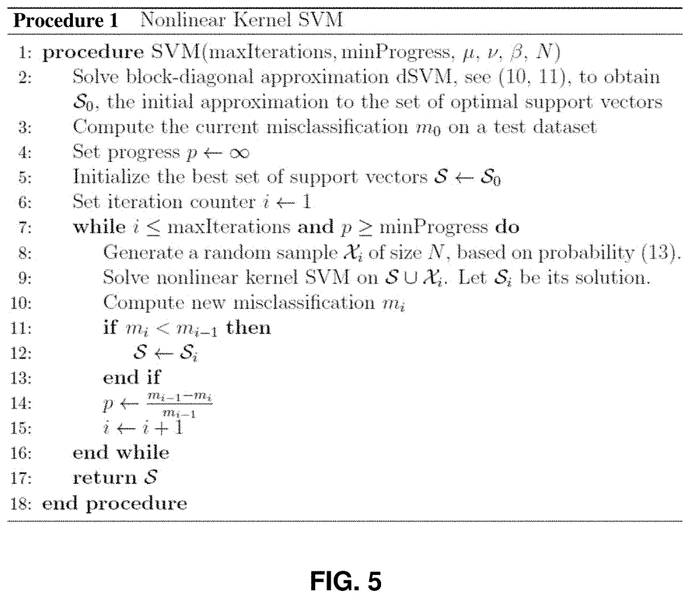

Let S be the initial set of support vectors, obtained by solving the dSVM. To improve it, we randomly choose N (e.g., N=20000) observations from the input data set X, where each point x is drawn with probability

$${( μ + v \vert b + {\sum }_{i} {α}_{i} {y}_{i} k ( {x}_{i} , x ) \vert )}^{- β} \qquad ( 13 )$$

where μ, v, β>0 are associated parameters, whose values can be chosen via, e.g., Bayesian optimization. Let X₀ be the resultant set. At the next step we solve the nonlinear SVM model on the union [symbol] ∪ [symbol] ₀. This procedure can be repeated a number of times. The stopping criteria can be
1. maximum number of models (maxIterations>0)
2. minimal improvement of the solution quality (0<minProgress<1)
   The resultant technique is illustrated by the pseudocode which appears in FIG. 5.

### Improving Operation of a Monitored System

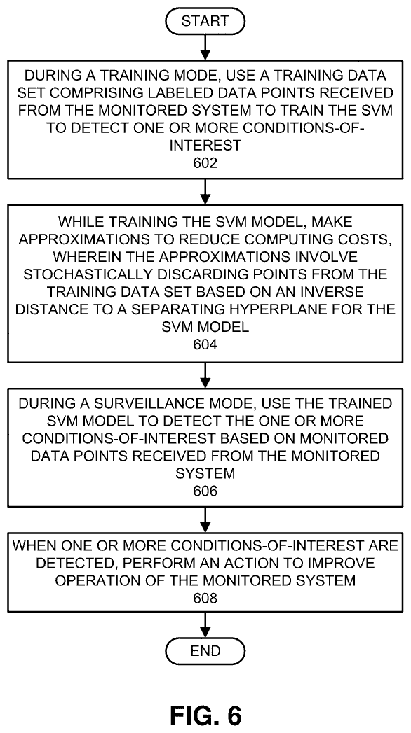

FIG. 6 presents a flowchart illustrating operations the system performs to improve operation of a monitored system in accordance with the disclosed embodiments. During a training mode, the system uses a training data set comprising labeled data points received from the monitored system to train the

SVM to detect one or more conditions-of-interest (step 602). While training the SVM model, the system makes approximations to reduce computing costs, wherein the approximations involve stochastically discarding points from the training data set based on an inverse distance to a separating hyperplane for the SVM model (step 604). Next, during a surveillance mode, the system uses the trained SVM model to detect the one or more conditions-of-interest based on monitored data points received from the monitored system (step 606). When one or more conditions-of-interest are detected, the system performs an action to improve operation of the monitored system (step 608).

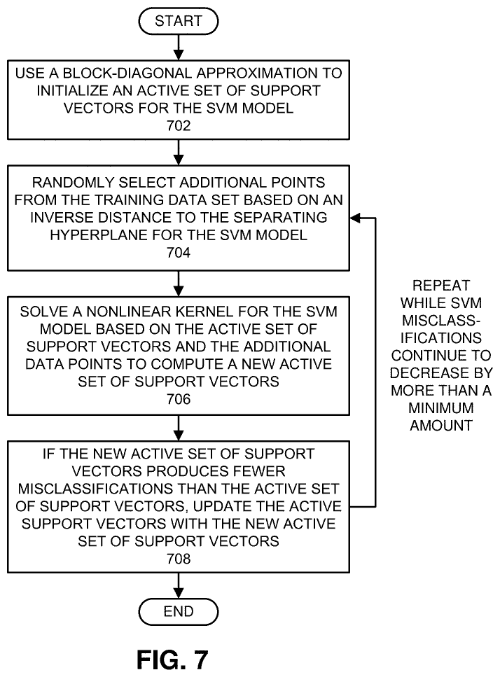

FIG. 7 presents a flowchart illustrating the process of training the SVM model in accordance with the disclosed embodiments. First, the system uses a block-diagonal approximation to initialize an active set of support vectors for the SVM model (step 702). Next, the system iteratively performs the following operations to improve the SVM model while SVM misclassifications continue to decrease by more than a minimum amount. First, the system randomly selects additional points from the training data set based on an inverse distance to the separating hyperplane for the SVM model (step 704). Next, the system solves a nonlinear kernel for the SVM model based on the active set of support vectors and the additional data points to compute a new active set of support vectors (step 706). If the new active set of support vectors produces fewer misclassifications than the active set of support vectors, the system updates the active support vectors with the new active set of support vectors (step 708).

### Summary

We propose using a block-diagonal approximation to produce an initial set of support vectors. We also propose a way to generate random samples, which provides a higher probability of inclusion for points that are closer to the separating hyperplane (in the transformed feature space). Indeed, the standard way of solving large scale SVM models today would focus on random sampling of the input data, which produces significantly lower model accuracy than our new technique.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for improving operation of a monitored system, comprising:
during a training mode,
using a training data set comprising labeled data points received from the monitored system to train the SVM to detect one or more conditions-of-interest, and
while training the SVM model, making approximations to reduce computing costs, wherein making the approximations comprises stochastically discarding points from the training data set based on an inverse distance to a separating hyperplane for the SVM model; and
during a surveillance mode,
using the trained SVM model to detect the one or more conditions-of-interest based on monitored data points received from the monitored system, and
when one or more conditions-of-interest are detected, performing an action to improve operation of the monitored system.

2. The method of claim 1, wherein while training the SVM model, the method performs the following operations:
using a block-diagonal approximation to initialize an active set of support vectors for the SVM model; and
iteratively performing the following operations to improve the SVM model while SVM misclassifications continue to decrease by more than a minimum amount,
randomly selecting additional points from the training data set based on an inverse distance to the separating hyperplane for the SVM model,
solving a nonlinear kernel for the SVM model based on the active set of support vectors and the additional data points to compute a new active set of support vectors, and
if the new active set of support vectors produces fewer misclassifications than the active set of support vectors, updating the active support vectors with the new active set of support vectors.

3. The method of claim 2, wherein while randomly selecting the additional points, the method selects an additional point x from the training data set with a probability P(x)=(μ+v d(x))^{-β}, wherein d(x) represents a distance from x to the separating hyperplane, and μ, v and β represent associated parameters.

4. The method of claim 1, wherein the SVM model is formulated based on one of the following types of kernels:
a linear kernel;
a polynomial kernel;
a hyperbolic tangent kernel; and
a radial basis function kernel.

5. The method of claim 1, wherein the monitored system comprises one of the following:
a computer system;
a database system;
a website;
an online customer-support system;
a vehicle;
an aircraft;
a utility system asset; and
a piece of machinery.

6. The method of claim 1, wherein data points received from the monitored system include one or more of the following:
time-series sensor signals;
computer parameters;
textual data;
numerical data; and
image data.

7. The method of claim 1, wherein detecting the one or more conditions-of-interest comprises detecting one or more of the following:
an impending failure of the monitored system;
a malicious-intrusion event in the monitored system;
a preventive-maintenance condition for the monitored system;
a fraud condition for the monitored system;
a product-purchasing condition for the monitored system; and
a consumer-attrition condition for the monitored system.

8. The method of claim 1, wherein performing the action to improve operation of the monitored system comprises one or more of the following:
sending a notification to an administrator of the monitored system;
performing an action to stop a malicious-intrusion event in the monitored system;
scheduling a maintenance operation for the monitored system;
performing an action to stop an instance of fraud associated with the monitored system;
performing an action to make relevant offers to customers associated with the monitored system; and
performing an action to improve satisfaction of a customer associated with the monitored system.

9. A non-transitory computer-readable storage medium storing instructions that when executed by a computer cause the computer to perform a method for improving operation of a monitored system, the method comprising:
during a training mode,
using a training data set comprising labeled data points received from the monitored system to train the SVM to detect one or more conditions-of-interest, and
while training the SVM model, making approximations to reduce computing costs, wherein making the approximations comprises stochastically discarding points from the training data set based on an inverse distance to a separating hyperplane for the SVM model; and
during a surveillance mode,
using the trained SVM model to detect the one or more conditions-of-interest based on monitored data points received from the monitored system, and
when one or more conditions-of-interest are detected, performing an action to improve operation of the monitored system.

10. The non-transitory computer-readable storage medium of claim 9, wherein while training the SVM model, the method performs the following operations:
using a block-diagonal approximation to initialize an active set of support vectors for the SVM model; and
iteratively performing the following operations to improve the SVM model while SVM misclassifications continue to decrease by more than a minimum amount,
randomly selecting additional points from the training data set based on an inverse distance to the separating hyperplane for the SVM model,
solving a nonlinear kernel for the SVM model based on the active set of support vectors and the additional data points to compute a new active set of support vectors, and
if the new active set of support vectors produces fewer misclassifications than the active set of support vectors, updating the active support vectors with the new active set of support vectors.

11. The non-transitory computer-readable storage medium of claim 10, wherein while randomly selecting the additional points, the method selects an additional point x from the training data set with a probability P(x)=(μ+v d(x))^{-β}, wherein d(x) represents a distance from x to the separating hyperplane, and μ, v and β represent associated parameters.

12. The non-transitory computer-readable storage medium of claim 9, wherein the SVM model is formulated based on one of the following types of kernels:
a linear kernel;
a polynomial kernel;
a hyperbolic tangent kernel; and
a radial basis function kernel.

13. The non-transitory computer-readable storage medium of claim 9, wherein the monitored system comprises one of the following:
a computer system;
a database system;
a website;
an online customer-support system;
a vehicle;
an aircraft;
a utility system asset; and
a piece of machinery.

14. The non-transitory computer-readable storage medium of claim 9, wherein data points received from the monitored system include one or more of the following:
time-series sensor signals;
computer parameters;
textual data;
numerical data; and
image data.

15. The non-transitory computer-readable storage medium of claim 9, wherein detecting the one or more conditions-of-interest comprises detecting one or more of the following:
an impending failure of the monitored system;
a malicious-intrusion event in the monitored system;
a preventive-maintenance condition for the monitored system;
a fraud condition for the monitored system;
a product-purchasing condition for the monitored system; and
a consumer-attrition condition for the monitored system.

16. The non-transitory computer-readable storage medium of claim 9, wherein performing the action to improve operation of the monitored system comprises one or more of the following:
sending a notification to an administrator of the monitored system;
performing an action to stop a malicious-intrusion event in the monitored system;
scheduling a maintenance operation for the monitored system;
performing an action to stop an instance of fraud associated with the monitored system;
performing an action to make relevant offers to customers associated with the monitored system; and
performing an action to improve satisfaction of a customer associated with the monitored system.

17. A system that improves operation of a monitored system, comprising:
at least one processor and at least one associated memory; and
an optimization mechanism that executes on the at least one processor,
wherein during a training mode, the optimization mechanism,
uses a training data set comprising labeled data points received from the monitored system to train the SVM to detect one or more conditions-of-interest, and
while training the SVM model, makes approximations to reduce computing costs, wherein making the approximations comprises stochastically discarding points from the training data set based on an inverse distance to a separating hyperplane for the SVM model; and
wherein during a surveillance mode, the optimization mechanism,
uses the trained SVM model to detect the one or more conditions-of-interest based on monitored data points received from the monitored system, and
when one or more conditions-of-interest are detected, performs an action to improve operation of the monitored system.

18. The system of claim 17, wherein while training the SVM model, the optimization mechanism performs the following operations:
uses a block-diagonal approximation to initialize an active set of support vectors for the SVM model; and
iteratively performs the following operations to improve the SVM model while SVM misclassifications continue to decrease by more than a minimum amount,
randomly selecting additional points from the training data set based on an inverse distance to the separating hyperplane for the SVM model,
solving a nonlinear kernel for the SVM model based on the active set of support vectors and the additional data points to compute a new active set of support vectors, and
if the new active set of support vectors produces fewer misclassifications than the active set of support vectors, updating the active support vectors with the new active set of support vectors.

19. The system of claim 18, wherein while randomly selecting the additional points, the optimization mechanism selects an additional point x from the training data set with a probability P(x)=(μ+v d(x))^{-β}, wherein d(x) represents a distance from x to the separating hyperplane, and μ, v and β represent associated parameters.

20. The system of claim 17, wherein the SVM model is formulated based on one of the following types of kernels:
a linear kernel;
a polynomial kernel;
a hyperbolic tangent kernel; and
a radial basis function kernel.
